(19) United States
(12) Patent Application Publication
(10) Pub. No.: US 2024/0244117 A1
(43) Pub. Date: Jul. 18, 2024

(54) ORCHESTRATION OF AIRGROUP POLICY FOR AUTOMATED SERVICE MONITORING AND MEASUREMENT IN AN ENTERPRISE WLAN SYSTEM

(71) Applicant: Hewlett Packard Enterprise Development LP, Spring, TX (US)

(72) Inventors: Hao Lu, Fremont, CA (US); Rahul Bahal, Danville, CA (US); Shanmuga Mari Shanmugam, Bangalore (IN)

(21) Appl. No.: 18/098,087

(22) Filed: Jan. 17, 2023

(51) Int. Cl. H04L 67/51; H04L 41/12; H04L 61/4511

(52) U.S. Cl. CPC H04L 67/51; H04L 41/12; H04L 61/4511; H04W 84/12

(57) ABSTRACT

A network monitoring system sends, to a wireless local area network (WLAN), registration information associated with a monitoring unit of the monitoring system, wherein the monitoring unit communicates with and is located within a predetermined distance of an access point of the WLAN. The network monitoring system receives a list of discoverable servers in the WLAN associated with the monitoring unit and generates instructions to be configured on the monitoring unit and executed by the access point. The instructions indicate performing discovery based on a multicast Domain Name Service (mDNS) protocol and determining reachability of the discoverable servers. The network monitoring system obtains metrics associated with the mDNS discovery and server reachability information. The network monitoring system integrates with the WLAN by synchronizing the obtained metrics and information. The WLAN orchestrates policies for the network monitoring system based on the integration of the network monitoring system and the WLAN.

### BACKGROUND

### Field

Service visibility for enterprise wireless local area network (WLAN) systems can be critical to daily network operations. Multicast protocols such as multicast Domain Name Service (mDNS) and Discovery and Launch (DIAL) can be used for “zero configuration networking.” These protocols may work well within a single virtual local area network (VLAN)/subnet, but certain issues may arise in an enterprise WLAN, including: service discovery does not work across VLANs; multicast may be unreliable over WLAN; and multicast may result in certain security issues.

### BRIEF DESCRIPTION OF THE FIGURES

FIG. 1A illustrates a diagram of a role-based mDNS service discovery, including a printer service allowed to a guest role, in accordance with an aspect of the present application.

FIG. 1B illustrates a diagram of a role-based mDNS service discovery, including a video streaming service not allowed to a guest role, in accordance with an aspect of the present application.

FIG. 2 illustrates an architecture which facilitates orchestration of policies for service monitoring and measurement in a network, in accordance with an aspect of the present application.

FIG. 3 presents a flowchart illustrating a method which facilitates orchestration of policies for service monitoring and measurement in a network, in accordance with an aspect of the present application.

FIG. 4A presents a flowchart illustrating a method which facilitates orchestration of policies for service monitoring and measurement in a network, in accordance with an aspect of the present application.

FIG. 4B presents a flowchart illustrating a method which facilitates orchestration of policies for service monitoring and measurement in a network, in accordance with an aspect of the present application.

FIG. 4C presents a flowchart illustrating a method which facilitates orchestration of policies for service monitoring and measurement in a network, in accordance with an aspect of the present application.

FIG. 5 illustrates a computer system (e.g., as part of a network monitoring system) which facilitates orchestration of policies for service monitoring and measurement in a network, in accordance with an aspect of the present application.

FIG. 6 illustrates a computer system (e.g., as part of an enterprise WLAN) which facilitates orchestration of policies for service monitoring and measurement in a network, in accordance with an aspect of the present application.

In the figures, like reference numerals refer to the same figure elements.

### DETAILED DESCRIPTION

The following description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Service visibility for enterprise wireless local area network (WLAN) systems is critical to daily network operations. Multicast protocols such as mDNS and DIAL can be used for “zero configuration networking,” in which a network of devices can be automatically created without having to manually configure a Dynamic Host Configuration Protocol (DHCP) server, DNS services, or network settings for each individual device desired to be connected to the network of devices. For example, Apple Bonjour is a zero configuration networking which can be used on Apple devices to discover mDNS-based services such as Airgroup services (e.g., Airplay and Airprint). This method can work well within a single virtual local area network (VLAN)/subnet, such as a home network.

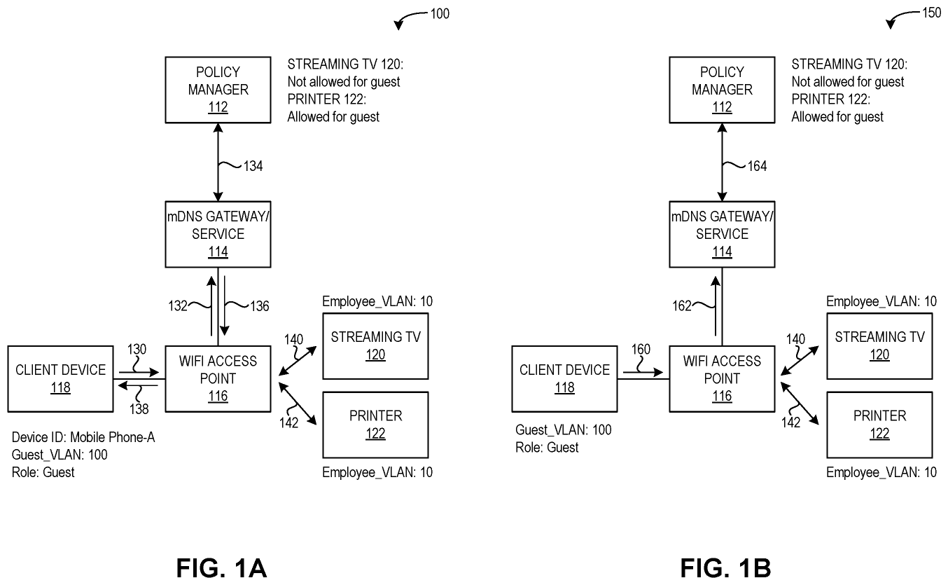

However, in an enterprise WLAN, certain limitations may arise when using multicast protocols for zero configuration networking. Service discovery may not work across different VLANs. Additionally, multicast may be unreliable over WLAN. Furthermore, multicast may result in certain security issues, e.g., various mDNS-based attacks via sniffing in the same Layer-2 domain. In some current solution, WLAN vendors may build their own mDNS discovery intelligence on their network devices, which solutions focus mainly on controlling the service discovery process based on network policies (e.g., the end user's role, location, etc.) Other solutions may involve processing service discovery on a remote device via a tunnel, in which an access point may send a client's mDNS request to a remote WLAN controller and that remote WLAN controller can construct the mDNS response based on the configured policies. The remote WLAN controller can subsequently send the mDNS response to the client via the access point, as described below in relation to FIGS. 1A and 1B. Still other solutions may involve the access point directly constructing the mDNS response, if the access point has knowledge of the desired policies and mDNS server caches. A cloud service may be used which can orchestrate the desired policies and distribute the server caches to the access point.

However, these solutions do not provide any visibility on the service discovery process. For example, these solutions do not provide information such as: the number of service discovery failures which may have occurred in the past 24 hours (or other period of time) for a specific mDNS service/server; how quickly those services may become available again for participating clients; and other metrics relating to service discovery or server reachability.

Furthermore, while these solutions may work for smaller VLANs which have static configurations (e.g., based on non-changing policies), in an enterprise WLAN, the policies may be dynamic and temporary (e.g., based on constantly-changing policies). Thus, a policy-based service discovery can result in making the process dynamic, which can result in discoverable services for a certain end-user changing from time to time (e.g., periodically or based on a change in a policy or configuration). For example, a device with a user in a guest role may only be able to access an Apple TV in a certain conference room for a given amount of time (e.g., a previously reserved or allotted time). Such dynamic situations can drive the need for a network monitoring system which can provide metrics and information on whether the discovery policies have been properly executed, including at the right location and at the right time in the network.

Some current solutions involve network monitoring systems built by specific vendors to monitor a specific customer network. In general, those network monitoring systems function as a “sidecar” of the main customer network system and are based on mimicking the behavior of an end user. For example, network monitoring systems designed to monitor network services (such as DHCP, 802.1x standard (“dot1x”), etc.) may also be used to monitor mDNS activities. In order to monitor, e.g., Airgroup, a network administrator must configure the Airgroup services to be monitored and also provide an expected server list for each Airgroup service running in the network. Such a network monitoring system can subsequently generate mDNS-similar traffic to the network, report an incident if any of the servers in the expected list is not discoverable, and collect certain metrics such as an mDNS retry, delay, etc., to measure the performance of the discovery process. However, in an enterprise WLAN, the number of mDNS servers to be monitored may be quite large. Given the high volume of servers as well as the dynamic policies, the challenge remains to efficiently configure a network monitoring system.

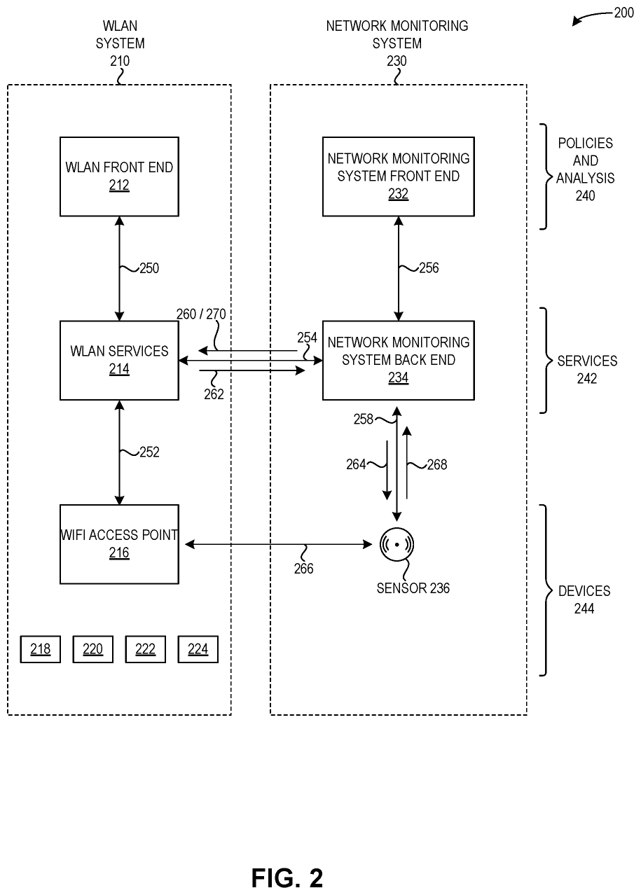

The described aspects address this challenge by providing a network monitoring system which securely integrates with the enterprise WLAN system. The WLAN system can include: a WLAN front end; a WLAN back end (e.g., WLAN services); one or more access points; and a plurality of client devices which may attempt to connect to the WLAN back end via an access point. The network monitoring system can include: a monitoring front end; a monitoring back end; and monitoring units (e.g., a sensor, software running on a general-purpose computer, or a wireless device which communicates with the sensor and is controlled by the network monitoring system). The WLAN back end can orchestrate service and server policies (e.g., Airgroup service/server policies) for the integrated network monitoring system over a secure connection. This orchestration can drive the automated service discovery and the network monitoring system. Furthermore, the network monitoring system can obtain results (e.g., metrics associated with mDNS discovery and information indicating server reachability) from its sensors, which results can be returned to either or both of the WLAN front end and the network monitoring system front end (e.g., to be displayed on separate dashboards or on a centralized dashboard). An architecture which securely integrates a network monitoring system with a WLAN system, as well as communications between the various entities of the network monitoring system and the WLAN system, is described below in relation to FIG. 2.

The term “front end” is used in this disclosure to describe applications, devices, displays, components, units, and input/output (I/O) devices which allow users to access and interact with a system, e.g., focusing on providing visual information and access to a user via a dashboard or other similar visual tool.

The term “back end” is used in this disclosure to describe indirectly linked devices which can respond to end user activities or requests (e.g., routers, network servers, email servers, etc.), e.g., focusing on the structure, system, data, and logic of the servers or services.

The term “WLAN services” is used to describe a back end service of an enterprise WLAN, which can perform the operations described herein. While the described aspects and Figures detail a WLAN as the network which is monitored by the network monitoring system, the described aspects may also be used with any network which can be monitored and includes wireless devices connecting or connected to a network.

The term “network monitoring system” is used to describe the aspects of an integrated network monitoring system which communicates with the WLAN system to perform the operations described herein. While the network monitoring system of the instant application is described and depicted as a separate system from the network being monitored (e.g., the WLAN system), aspects of the instant application can include a network monitoring system which is physically integrated with the WLAN system.

The term “monitoring unit” is used to describe a component, components, device, or devices which can communicate with one or more devices and can perform monitoring of one or more devices. Examples of a monitoring unit can include a sensor, a wireless device which communicates with the sensor and is controllable by the network monitoring system, and software installed and running on the wireless device.

### Examples of Role-Based mDNS Discovery

As described above, some current solution in a WLAN may not provide visibility into the service discovery process. In solutions which focus on controlling the service discovery process based on network policies (e.g., the end user's role, location, etc.) or processing service discovery on a remote device via a tunnel, an access point may send a client's mDNS request to a remote WLAN controller and that remote WLAN controller can construct the mDNS response based on the configured policies, as described below in relation to FIGS. 1A and 1B.

FIG. 1A illustrates a diagram 100 of a role-based mDNS service discovery, including a printer service allowed to a guest role, in accordance with an aspect of the present application. Diagram 100 can include: a policy manager 112; an mDNS gateway/service 114; a WiFi access point 116; a client device 118; and two wireless services/servers/devices (a streaming TV 120 and a printer 122). For the purpose of illustration, the wireless services can be Airgroup services which are based on Airgroup policies (e.g., streaming TV 120 can be an Apple TV, printer 122 can be an Apple printer, and the requests sent to mDNS gateway/service 114 can be based on Airgroup services). Client device 118 may be associated an identifier of “Mobile Phone-A” and a guest_VLAN 100 with a role of “Guest” and both streaming TV 120 and printer 122 can be associated with an employee_VLAN 10. Client device 118 can send an mDNS request to access point 116, requesting a list or indication of which devices are available to client device 118 for, e.g., printing services (via a communication 130). Access point 116 can receive the mDNS request and send a specific Airgroup request to mDNS gateway/service 114 (via a communication 132). This request can indicate that a client device with the device ID of “Mobile Phone-A” on a VLAN 100 with the role of “Guest” requests a list of accessible printing services. mDNS gateway/service 114 can determine, from policy manager 112 (via a communication 134), that printer 122 is allowed for the “Guest” role (and that streaming TV 120 is not allowed for the “Guest” role). mDNS gateway/service 114 can send an Airgroup response to access point 116 (via a communication 136), indicating that printer 122 is available, along with information relating to the printer, such as the Internet Protocol (IP) address, port number, VLAN, etc. Access point 116 can receive this Airgroup response and send to client device 118 an mDNS response (via a communication 138), which indicates that printer 122 is available, along with the associated printer information. Thus, diagram 100 depicts the communications which result in printer 122 being shared to client device 118 in the “Guest” role.

FIG. 1B illustrates a diagram 150 of a role-based mDNS service discovery, including a video streaming service not allowed to a guest role, in accordance with an aspect of the present application. Diagram 100 can include the same entities as diagram 100: policy manager 112; mDNS gateway/service 114; WiFi access point 116; client device 118; and two wireless services/servers/devices (a streaming TV 120 and a printer 122). As in diagram 100, client device 118 may be associated an identifier of “Mobile Phone-A” and a guest_VLAN 100 with a role of “Guest” and both streaming TV 120 and printer 122 can be associated with an employee_VLAN 10. Client device 118 can send an mDNS request to access point 116, requesting a list or indication of which devices are available to client device 118 for, e.g., video streaming services (via a communication 160). Access point 116 can receive the mDNS request and send a specific Airgroup request to mDNS gateway/service 114 (via a communication 162). This request can indicate that a client device with the device ID of “Mobile Phone-A” on a VLAN 100 with the role of “Guest” requests a list of accessible video streaming services. mDNS gateway/service 114 can determine, from policy manager 112 (via a communication 134), that streaming TV 120 is not allowed for the “Guest” role (and that printer 122 is allowed for the “Guest” role). mDNS gateway/service 114 can send no response to access point 116, which can send no response back to client device 118, which indicates that no video streaming services are available for client device 118. mDNS gateway/service can also send an Airgroup response (not shown) to access point 116 indicating that no video streaming services are available or allowed for client device 118, and access point 116 can send to client device 118 an mDNS response (not shown) which indicates that no video streaming services are available or allowed for client device 118. Thus, diagram 100 depicts the communications which result in streaming TV 120 not being shared to client device 118 in the “Guest” role.

Architecture of Integrated Network Monitoring System with WLAN System

The role-based mDNS service discovery of FIGS. 1A and 1B does not provide visibility into the actual service discovery process itself. Therefore, given constantly changing dynamic and temporary policies in an enterprise WLAN with a very large number of mDNS servers which need to be monitored, the process described above may not scale and may not be efficient in the enterprise WLAN scenario.

FIG. 2 illustrates an architecture 200 which facilitates orchestration of policies for service monitoring and measurement in a network, in accordance with an aspect of the present application. Architecture 200 can include a WLAN system 210 and a network monitoring system 230. WLAN system 210 can include: a WLAN front end 212; WLAN services 214; a WiFi access point 216; and wireless client devices or services 218, 220, 222, and 224, e.g., a mobile phone 218, a laptop 220, an Apple Printer 222, and a streaming video service 224 (such as an Apple TV 224). Network monitoring system 230 can include: a network monitoring system front end 232; a network monitoring system back end 234; and a sensor 236. WLAN system 210 and network monitoring system 230 can include these entities or components as groups or “layers” which can correlate or communicate with each other. For example: a policies and analysis group or layer 240 can include WLAN front end 212 and network monitoring system front end 232; a services group or layer 242 can include WLAN services 214 and network monitoring system back end 234; and a devices group or layer 244 can include access point 216 and sensor 236 (as well as client devices and services 218-222). WLAN services 214 and network monitoring system back end 234 can communicate over a secure connection or channel (e.g., via a communication 254).

Network monitoring system back end 234 can determine registration information associated with sensor 236. Sensor 236 can communicate with and be located on or near (i.e., within a predetermined distance of) access point 216 of WLAN system 210. Network monitoring system back end 234 can send, to WLAN services 214, a message indicating registration information associated with sensor 236 (via a communication 260). WLAN services 214 can generate and send to network monitoring system back end 234 a list of discoverable servers for sensor 236 (via a communication 262), which list can be based on policies managed by WLAN system 210. Network monitoring system 234 can receive the list of discoverable servers in WLAN system 210 which are associated with sensor 236 (via communication 262). Network monitoring system 234 can generate, based on the list of discoverable servers, instructions to be configured on sensor 236 and executed by access point 216. The instructions can indicate performing discovery based on an mDNS protocol and determining reachability of the discoverable servers (e.g., an mDNS request). Network monitoring system 234 can communicate with sensor 236 via a communication 258. Specifically, networking monitoring system can configure sensor 236 based on the generated instructions (via a communication 264).

Based on the configured instructions, sensor 236 can monitor one or more services indicated in the registration information, e.g., by sending the generated instructions (i.e., the mDNS request) to access point 216 to be executed by access point 216 (via a communication 266). Access point 216 can execute the generated instructions (e.g., via a communication 252 with WLAN services 214 and communications with devices providing services (e.g., 222 and 224) relating to a device (e.g., 218 and 220) which may have requested access to access point 216, which request can be monitored by sensor 236. Access point 216 can return results of the executed instructions to sensor 236 (via communication 266). Sensor 236 can obtain from access point 216 metrics associated with the mDNS discovery and information indicating the determined server reachability (via communication 266) and send the obtained metrics and information to network monitoring system back end 234 (via a communication 268). Network monitoring system 230 can integrate with WLAN system 210 by synchronizing the obtained metrics and information with WLAN services 214 (via a communication 270). WLAN system 210 can thus orchestrate, by WLAN services 214, policies for network monitoring system 230 based on the integration of network monitoring system 230 and WLAN system 210.

Network monitoring system back end 234 can send the obtained metrics and information to network monitoring system front end 232 (via a communication 256), e.g., to be displayed as a dashboard on a display device of network monitoring system 230 (and associated with network monitoring system back end 234). This can allow a user (not shown) associated with the display to modify, via the dashboard, the generated instructions to be configured on the sensor and executed by the access point. In addition, WLAN services 214 can send the obtained metrics and results to WLAN front end 212 (via a communication 250), e.g., to be displayed on a display device of WLAN system 210 (and associated with WLAN services 214). In some aspects, network monitoring system 230 may be a part of WLAN system 210, e.g., physically integrated in an “overall system,” where the display of the obtained metrics and information may appear on a single display which serves as part of a front end for the overall system.

The obtained and subsequently displayed metrics and information can include: errors detected by sensor 236; latency measurements, i.e., of the performance of the process of discovering (request/response time) the servers or services indicated in the instructions (and based on the device registration message sent to WLAN services 214); and latency measurements in real time. In addition to providing visibility to the service discovery process, the described aspects can be leveraged to provide an automated high-level intelligence function to coordinate network resources in an enterprise WLAN.

The system (i.e., the secure integration of WLAN system 210 and network monitoring system 230) can monitor network attributes associated with sensor 236, including network attributes associated with access point 216 and the discoverable servers/services. In monitoring the network attributes, the system may also detect certain policy and configuration changes, e.g., changes to the role or location of a user of a device searching for discoverable servers via access point 216 and changes to a location of access point 216 or an end device or service associated with the access point (e.g., 218-224). When such changes are detected, the system can provide updated discoverable lists. For example, if the system detects a change in a network attribute associated with sensor 236, WLAN services 214 can send to network monitoring system back end 234 an updated list of discoverable servers for sensor 236. If the system detects a change in a policy managed by WLAN services 214, WLAN services 214 can send to network monitoring system back end 234 an updated list for sensor 236 (and all sensors affected by the change in the policy). If the system detects a change in a global cache associated with all servers of WLAN system 210, WLAN services 214 can send to network monitoring system back end 234 an updated list for all sensors affected by the change in the global cache.

Thus, the described communications of FIG. 2 between WLAN system 210 and network monitoring system 230 (and also among components of each system) illustrate how the WLAN system can orchestrate policies which result in automated service monitoring and measurement by the network monitoring system.

### Method for Facilitating Orchestration of Airgroup Policy for Automated Service Monitoring and Measurement in an Enterprise WLAN

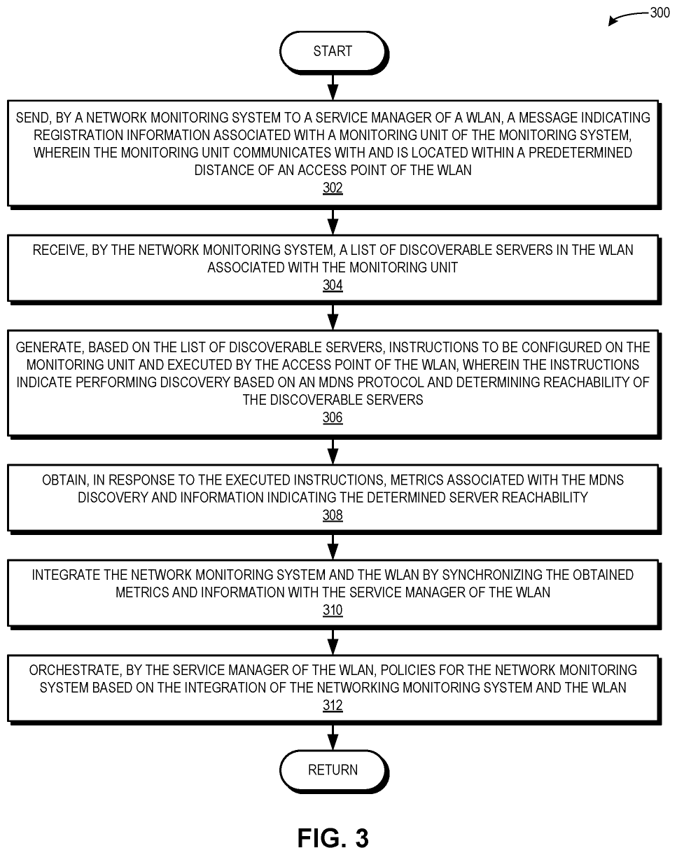

FIG. 3 presents a flowchart 300 illustrating a method which facilitates orchestration of policies for service monitoring and measurement in a network, in accordance with an aspect of the present application. During operation, the system sends, by a network monitoring system to a service manager of a WLAN, a message indicating registration information associated with a monitoring unit of the monitoring system, wherein the monitoring unit communicates with and is located within a predetermined distance of an access point of the WLAN (operation 302). The system receives, by the network monitoring system, a list of discoverable servers in the WLAN associated with the monitoring unit (operation 304). The system generates, based on the list of discoverable servers, instructions to be configured on the monitoring unit and executed by the access point of the WLAN, wherein the instructions indicate performing discovery based on an mDNS protocol and determining reachability of the discoverable servers (operation 306). Configuring the instructions on the monitoring unit causes the monitoring unit to monitor one or more services indicated in the registration information. The system obtains, in response to the executed instructions, metrics associated with the mDNS discovery and information indicating the determined server reachability (operation 308). The system integrates the network monitoring system and the WLAN by synchronizing the obtained metrics and information with the service manager of the WLAN (operation 310). The system orchestrates, by the service manager of the WLAN, policies for the network monitoring system based on the integration of the network monitoring system and the WLAN (operation 312). The operation returns.

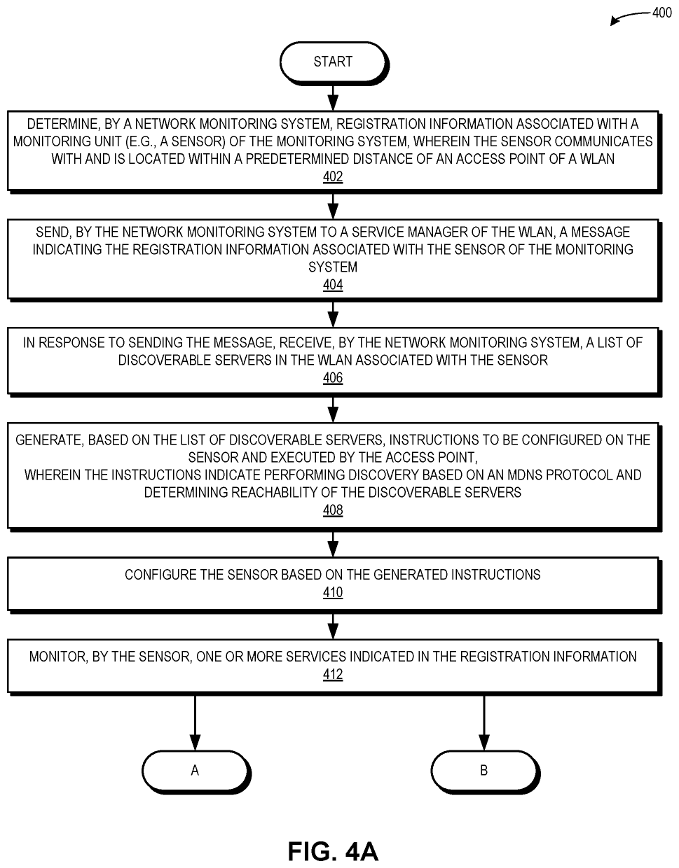

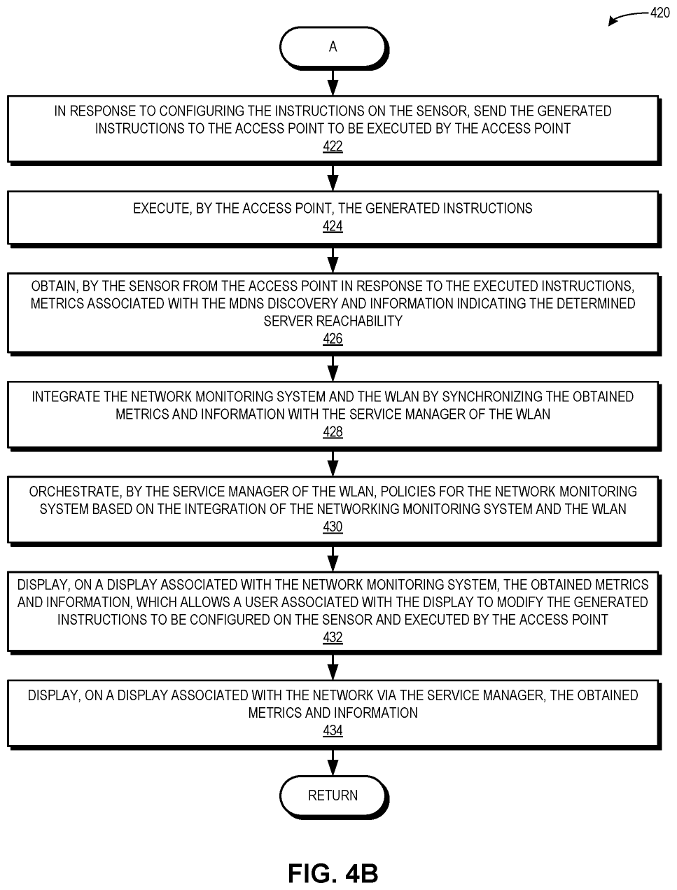

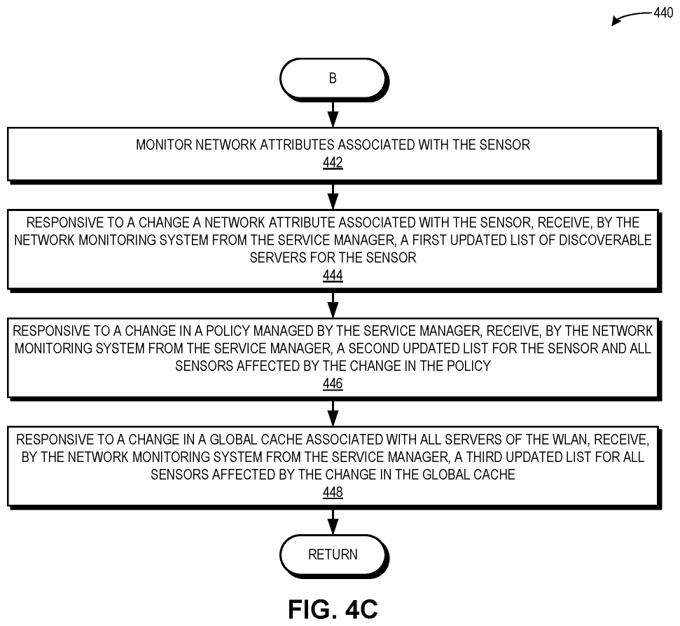

FIG. 4A presents a flowchart 400 illustrating a method which facilitates orchestration of policies for service monitoring and measurement in a network, in accordance with an aspect of the present application. During operation, the system determines, by a network monitoring system, registration information associated with a monitoring unit (e.g., a sensor) of the monitoring system, wherein the sensor communicates with and is located within a predetermined distance of an access point of a WLAN (operation 402). The system sends, by the network monitoring system to a service manager of the WLAN, a message indicating registration information associated with a sensor of the monitoring system (operation 404). In response to sending the message, the system receives, by the network monitoring system, a list of discoverable servers in the WLAN associated with the sensor (operation 406). The system generates, based on the list of discoverable servers, instructions to be configured on the sensor and executed by the access point of the WLAN, wherein the instructions indicate performing discovery based on an mDNS protocol and determining reachability of the discoverable servers (operation 408). The system configures the sensor based on the generated instructions (operation 410), and the system monitors, by the sensor, one or more services indicated in the registration information (operation 412). The operation continues at Label A of FIG. 4B and/or Label B of FIG. 4C.

FIG. 4B presents a flowchart 420 illustrating a method which facilitates orchestration of policies for service monitoring and measurement in a network, in accordance with an aspect of the present application. In response to configuring the instructions on the sensor, the system sends the generated instructions to the access point to be executed by the access point (operation 422). The system executes, by the access point, the generated instructions (operation 424). The system obtains, by the sensor from the access point in response to the executed instructions, metrics associated with the mDNS discovery and information indicating the determined server reachability (operation 426). The system integrates the network monitoring system and the WLAN by synchronizing the obtained metrics and information with the service manager of the WLAN (operation 428). The system orchestrates, by the service manager of the WLAN, policies for the network monitoring system based on the integration of the network monitoring system and the WLAN (operation 430). The system displays, on a display associated with the network monitoring system, the obtained metrics and information, which allows a user associated with the display to modify the generated instructions to be configured on the sensor and executed by the access point (operation 432). The system displays, on a display associated with the WLAN via the service manager, the obtained metrics and information (operation 434). As described above, the display of the obtained metrics and information may appear on a single display or dashboard which serves as part of a front end for an overall system in which the network monitoring system may be a part of or physically integrated with the WLAN. The operation returns.

FIG. 4C presents a flowchart 440 illustrating a method which facilitates orchestration of policies for service monitoring and measurement in a network, in accordance with an aspect of the present application. The system monitors network attributes associated with the sensor (operation 442). Responsive to a change in a network attribute associated with the sensor, the system receives, by the network monitoring system from the service manager, a first updated list of discoverable servers for the sensor (operation 444). Responsive to a change in a policy managed by the service manager, the system receives, by the network monitoring system from the service manager, a second updated list for the sensor and all sensors affected by the change in the policy (operation 446). Responsive to a change in a global cache associated with all servers of the WLAN, the system receives, by the network monitoring system from the service manager, a third updated list for all sensors affected by the change in the global cache (operation 448). The operation returns.

### Computer Systems Which Facilitate Orchestration of Airgroup Policy for Automated Service Monitoring and Measurement in an Enterprise WLAN

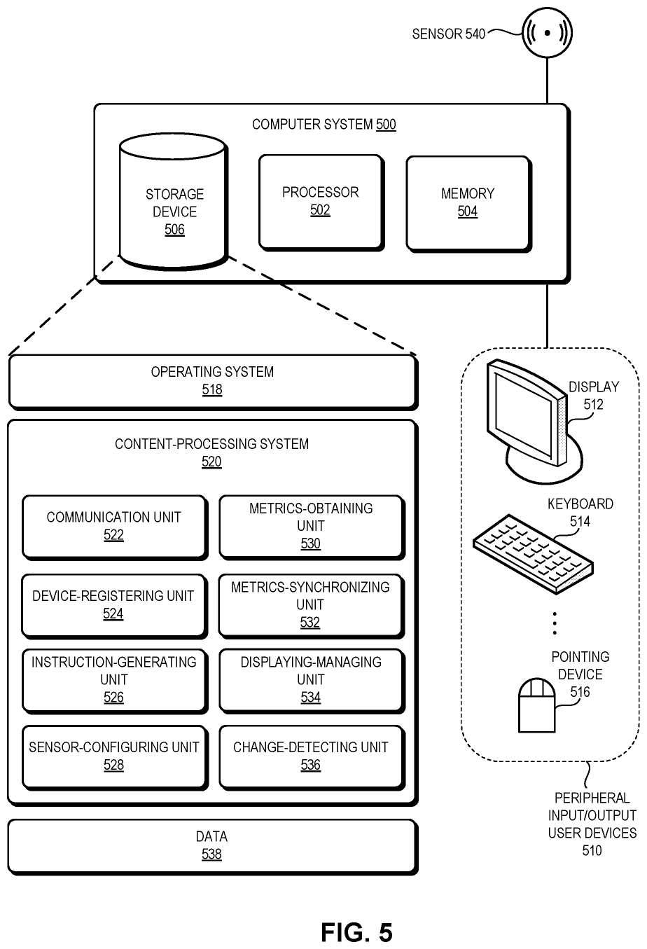

FIG. 5 illustrates a computer system 500 (e.g., as part of a network monitoring system) which facilitates orchestration of policies for service monitoring and measurement in a network, in accordance with an aspect of the present application. Computer system 500 includes a processor 502, a memory 504, and a storage device 506. Memory 504 can include a volatile memory (e.g., RAM) that serves as a managed memory, and can be used to store one or more memory pools. Furthermore, computer system 500 can be coupled to peripheral input/output user devices 510 (e.g., a display device 512, a keyboard 514, and a pointing device 516, which can comprise a front end system for computer system 500). Computer system 500 can communicate with a sensor 540, which can be located on, near, or within a predetermined distance of an access point of a network or WLAN which is to be monitored by computer system 500. Storage device 506 can store an operating system 518, a content-processing system 520, and data 538. Computer system 500 can correspond to network monitoring system back end 234 of FIG. 2.

Content-processing system 520 can include instructions, which when executed by computer system 500, can cause computer system 500 to perform methods and/or processes described in this disclosure. Specifically, content-processing system 520 may include instructions for sending and/or receiving data packets to/from other network nodes across a computer network (communication unit 522). A data packet can include a message, registration information, a list, instructions, metrics, information, and data related to the operations described herein.

Content-processing system 520 can further include instructions for sending, to a service manager of a WLAN, a message indicating registration information associated with a monitoring unit (e.g., sensor 540) of the monitoring system, wherein the monitoring unit communicates with and is located within a predetermined distance of an access point of the WLAN (communication unit 522 and device-registering unit 524). Content-processing system 520 can include instructions for receiving a list of discoverable servers in the WLAN associated with the monitoring unit (communication unit 522). Content-processing system 520 can include instructions for generating, based on the list of discoverable servers, instructions to be configured on the monitoring unit and executed by the access point of the WLAN, wherein the instructions indicate performing discovery based on an mDNS protocol and determining reachability of the discoverable servers (instruction-generating unit 526 and sensor-configuring unit 528). Content-processing system 520 can include instructions for obtaining, in response to the executed instructions, metrics associated with the mDNS discovery and information indicating the determined server reachability (metrics-obtaining unit 530). Content-processing system 520 can include instructions for integrating the network monitoring system and the WLAN by synchronizing the obtained metrics and information with the service manager of the WLAN (metrics-synchronizing unit 532). Content-processing system 520 can include instructions for orchestrating, by the service manager of the WLAN, policies for the network monitoring system based on the integration of the network monitoring system and the WLAN (metrics-synchronizing unit 532 and communication unit 522).

Content-processing system 520 can also include instructions for, subsequent to obtaining the metrics and information, displaying, on a display associated with the network monitoring system, the obtained metrics and information, which allows a user associated with the display to modify the generated instructions to be configured on the sensor and executed by the access point (display-managing unit 534).

Content-processing system 520 can additionally include instructions for monitoring network attributes associated with the sensor (change-detecting unit 536). Responsive to a change in, e.g., a network attribute associated with the sensor, a policy managed by the service manager, or a global cache associated with all the servers of the WLAN, content-processing system 520 can include instructions for receiving, from the service manager, an updated list of discoverable servers for, e.g., the sensor, the sensor and all sensors affected by the change in the policy, and all sensors affected by the change in the global cache (change-detecting unit 536, communication unit 522, and instruction-generating unit 526).

Data 538 can include any data that is required as input or that is generated as output by the methods and/or processes described in this disclosure. Specifically, data 538 can store at least: data; a message; registration information; information associated with a front end, a back end, and a sensor; a list; instructions; a request; a response; an updated list; a detected change; metrics associated with mDNS discovery; information indicating server reachability; latency information; and a policy.

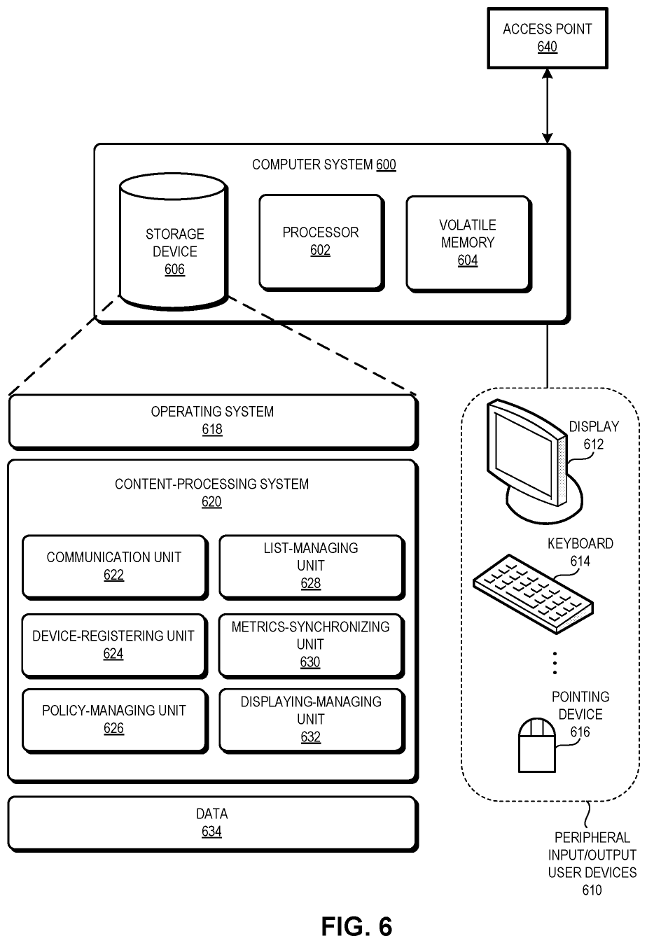

FIG. 6 illustrates a computer system 600 (e.g., as part of an enterprise WLAN) which facilitates orchestration of policies for service monitoring and measurement in a network, in accordance with an aspect of the present application. Computer system 600 includes a processor 602, a memory 604, and a storage device 606. Memory 604 can include a volatile memory (e.g., RAM) that serves as a managed memory, and can be used to store one or more memory pools. Furthermore, computer system 600 can be coupled to peripheral input/output user devices 610 (e.g., a display device 612, a keyboard 614, and a pointing device 616, which can comprise a front end system for computer system 600). Computer system 600 can communicate with an access point 640, which can be located near or within a predetermined distance of a sensor of a network monitoring system which is to monitor computer system 600. Storage device 606 can store an operating system 618, a content-processing system 620, and data 634. Computer system 600 can correspond to WLAN services 214 of FIG. 2.

Content-processing system 620 can include instructions, which when executed by computer system 600, can cause computer system 600 to perform methods and/or processes described in this disclosure. Specifically, content-processing system 620 may include instructions for sending and/or receiving data packets to/from other network nodes across a computer network (communication unit 622). A data packet can include a message, registration information, a list, instructions, metrics, information, a request, a response, policy or configuration information, an error notification, and data related to the operations described herein.

Content-processing system 620 can further include instructions for receiving a message indicating registration information associated with a sensor (e.g., sensor 540 of FIG. 5) of the monitoring system, wherein the sensor communicates with and is located within a predetermined distance of access point 640 (communication unit 622 and device-registering unit 624). Content-processing system 620 can include instructions for generating a list of discoverable servers in the WLAN associated with the sensor indicated in the registration message (list-managing unit 628). Content-processing system 620 can include instructions for obtaining and synchronizing, in response instructions configured on the sensor and executed by the access point, metrics associated with the mDNS discovery and information indicating the determined server reachability (metrics-synchronizing unit 630). Content-processing system 520 can include instructions for integrating the network monitoring system and the WLAN by synchronizing the obtained metrics and information with the service manager of the WLAN (metrics-synchronizing unit 630). Content-processing system 620 can include instructions for orchestrating, by the service manager of the WLAN, policies for the network monitoring system based on the integration of the network monitoring system and the WLAN (metrics-synchronizing unit 630, policy-managing unit 626, and communication unit 622).

Content-processing system 620 can additionally include instructions for, subsequent to synchronizing the obtained metrics and information with the service manager of the WLAN, displaying, on a display associated with the WLAN via the service manager, the obtained metrics and information (display-managing unit 632).

Data 634 can include any data that is required as input or that is generated as output by the methods and/or processes described in this disclosure. Specifically, data 634 can store at least: data; a message; registration information; information associated with a front end, a back end, and an access point; a list; a list of discoverable servers for a sensor; instructions; a request; a response; an updated list; a detected change; metrics associated with mDNS discovery; information indicating server reachability; latency information; and a policy.

In general, the disclosed aspects provide a method, a non-transitory computer-readable storage medium, and a computer system for facilitating orchestration of policies for service monitoring and measurement in a network. In one aspect, the system sends, by a network monitoring system to a service manager of a WLAN, a message indicating registration information associated with a monitoring unit of the monitoring system, wherein the monitoring unit communicates with and is located within a predetermined distance of an access point of the WLAN. The system receives, by the network monitoring system, a list of discoverable servers in the WLAN associated with the monitoring unit. The system generates, based on the list of discoverable servers, instructions to be configured on the monitoring unit and executed by the access point of the WLAN, wherein the instructions indicate performing discovery based on an mDNS protocol and determining reachability of the discoverable servers, wherein configuring the instructions on the monitoring unit causes the monitoring unit to monitor one or more services indicated in the registration information. The system obtains, in response to the executed instructions, metrics associated with the mDNS discovery and information indicating the determined server reachability. The system integrates the network monitoring system and the WLAN by synchronizing the obtained metrics and information with the service manager of the WLAN. The system orchestrates, by the service manager of the WLAN, policies for the network monitoring system based on the integration of the network monitoring system and the WLAN.

In a variation on this aspect, the registration information comprises at least one of: an identifier associated with the monitoring unit; a service set identifier associated with the monitoring unit; and a type of one or more services desired to be monitored.

In a further variation on this aspect, the type of the one or more services desired to be monitored comprises at least one of: an Airgroup service; an Airplay service; an Airprint service; a Chromecast service; and a service which leverages zero configuration networking. A respective discoverable server is associated with one of the type of the one or more services.

In a further variation on this aspect, the monitoring unit comprises at least one of: a sensor; a wireless device which communicates with the sensor and is controlled by the network monitoring system; and software installed and running on the wireless device.

In a further variation, configuring the instructions on the monitoring unit further causes the monitoring unit to send the instructions to the access point be executed by the access point. The instructions comprise a service discovery request and further indicate performing discovery based on at least one of the mDNS protocol and a Discovery and Launch (DIAL) protocol.

In a further variation, the system monitors network attributes associated with the monitoring unit. Responsive to a change in a network attribute associated with the monitoring unit, the system receives, by the network monitoring system from the service manager, a first updated list of discoverable servers for the monitoring unit. Responsive to a change in a policy managed by the service manager, the system receives, by the network monitoring system from the service manager, a second updated list for the monitoring unit and all monitoring units affected by the change in the policy. Responsive to a change in a global cache associated with all servers of the network, the system receives, by the network monitoring system from the service manager, a third updated list for all monitoring units affected by the change in the global cache.

In a further variation, the generated instructions further indicate at least one of: a frequency or interval at which to execute the instructions; and one or more servers or services on which to perform the mDNS discovery.

In a further variation, the WLAN comprises an enterprise wireless local area network.

In a further variation, subsequent to obtaining the metrics and information, the system displays, on a display associated with the network monitoring system, the obtained metrics and information, which allows a user associated with the display to modify the generated instructions to be configured on the monitoring unit and executed by the access point.

In a further variation, subsequent to synchronizing the obtained metrics and information with the service manager of the network, the system displays, on a display associated with the WLAN network via the service manager, the obtained metrics and information.

In a further variation, the obtained metrics and information are displayed on a display of an integrated system which comprises the WLAN and the network monitoring system.

In a further variation, the policies comprise at least one of: dynamic policies based on changes to a role or location of a user of a device searching for discoverable servers via the access point; and temporary policies based on changes to a location of an access point or an end device associated with the access point.

In another aspect, a non-transitory computer-readable storage medium stores instructions that when executed by a computer cause the computer to perform the method described above, including in relation to FIGS. 2, 3, 4A, and 4B.

In yet another aspect, a computer system comprises a processor and a storage device storing instructions that when executed by the processor cause the processor to perform the method described above, including in relation to FIGS. 2, 3, 4A, and 4B.

The foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
sending, by a network monitoring system to a service manager of a wireless local area network (WLAN), a message indicating registration information associated with a monitoring unit of the monitoring system, wherein the monitoring unit communicates with and is located within a predetermined distance of an access point of the WLAN;
receiving, by the network monitoring system, a list of discoverable servers in the WLAN associated with the monitoring unit;
generating, based on the list of discoverable servers, instructions to be configured on the monitoring unit and executed by the access point of the WLAN, wherein the instructions indicate performing discovery based on a multicast Domain Name Service (mDNS) protocol and determining reachability of the discoverable servers,
wherein configuring the instructions on the monitoring unit causes the monitoring unit to monitor one or more services indicated in the registration information;
obtaining, in response to the executed instructions, metrics associated with the mDNS discovery and information indicating the determined server reachability;
integrating the network monitoring system and the WLAN by synchronizing the obtained metrics and information with the service manager of the WLAN; and
orchestrating, by the service manager of the WLAN, policies for the network monitoring system based on the integration of the network monitoring system and the WLAN.

2. The method of claim 1, wherein the registration information comprises at least one of:
an identifier associated with the monitoring unit;
a service set identifier associated with the monitoring unit; and
a type of one or more services desired to be monitored.

3. The method of claim 2,
wherein the type of the one or more services desired to be monitored comprises at least one of:
an Airgroup service;
an Airplay service;
an Airprint service;
a Chromecast service; and
a service which leverages zero configuration networking, and
wherein a respective discoverable server is associated with one of the type of the one or more services.

4. The method of claim 1, wherein the monitoring unit comprises at least one of:
a sensor;
a wireless device which communicates with the sensor and is controlled by the network monitoring system; and
software installed and running on the wireless device.

5. The method of claim 1,
wherein configuring the instructions on the monitoring unit further causes the monitoring unit to send the instructions to the access point be executed by the access point, wherein the instructions comprise a service discovery request and further indicate performing discovery based on at least one of the mDNS protocol and a Discovery and Launch (DIAL) protocol.

6. The method of claim 1, further comprising:
monitoring network attributes associated with the monitoring unit;
responsive to a change in a network attribute associated with the monitoring unit, receiving, by the network monitoring system from the service manager, a first updated list of discoverable servers for the monitoring unit;
responsive to a change in a policy managed by the service manager, receiving, by the network monitoring system from the service manager, a second updated list for the monitoring unit and all monitoring units affected by the change in the policy; and
responsive to a change in a global cache associated with all servers of the WLAN, receiving, by the network monitoring system from the service manager, a third updated list for all monitoring units affected by the change in the global cache.

7. The method of claim 1, wherein the generated instructions further indicate at least one of:
a frequency or interval at which to execute the instructions; and
one or more servers or services on which to perform the mDNS discovery.

8. The method of claim 1,
wherein the WLAN comprises an enterprise wireless local area network.

9. The method of claim 1, further comprising:
subsequent to obtaining the metrics and information, displaying, on a display associated with the network monitoring system, the obtained metrics and information, which allows a user associated with the display to modify the generated instructions to be configured on the monitoring unit and executed by the access point.

10. The method of claim 1, further comprising:
subsequent to synchronizing the obtained metrics and information with the service manager of the WLAN, displaying, on a display associated with the WLAN via the service manager, the obtained metrics and information.

11. The method of claim 1,
wherein the obtained metrics and information are displayed on a display of an integrated system which comprises the WLAN and the network monitoring system.

12. The method of claim 1, wherein the policies comprise at least one of:
dynamic policies based on changes to a role or location of a user of a device searching for discoverable servers via the access point; and
temporary policies based on changes to a location of an access point or an end device associated with the access point.

13. A non-transitory computer-readable storage medium storing instructions that when executed by a computer cause the computer to perform a method, the method comprising:
sending, by a network monitoring system to a service manager of a wireless local area network (WLAN), a message indicating registration information associated with a monitoring unit of the monitoring system, wherein the monitoring unit communicates with and is located within a predetermined distance of an access point of the WLAN;
receiving, by the network monitoring system, a list of discoverable servers in the WLAN associated with the monitoring unit;
generating, based on the list of discoverable servers, instructions to be configured on the monitoring unit and executed by the access point of the WLAN, wherein the instructions indicate performing discovery based on a multicast Domain Name Service (mDNS) protocol and determining reachability of the discoverable servers,
wherein configuring the instructions on the monitoring unit causes the monitoring unit to monitor one or more services indicated in the registration information;
obtaining, in response to the executed instructions, metrics associated with the mDNS discovery and information indicating the determined server reachability;
integrating the network monitoring system and the WLAN by synchronizing the obtained metrics and information with the service manager of the WLAN; and
orchestrating, by the service manager of the WLAN, policies for the network monitoring system based on the integration of the network monitoring system and the WLAN.

14. The non-transitory computer-readable storage medium of claim 13,
wherein the registration information comprises at least one of:
an identifier associated with the monitoring unit;
a service set identifier associated with the monitoring unit; and
a type of one or more services desired to be monitored,
wherein the type of the one or more services desired to be monitored comprises at least one of:
an Airgroup service;
an Airplay service;
an Airprint service;
a Chromecast service; and
a service which leverages zero configuration networking,
wherein a respective discoverable server is associated with one of the type of the one or more services, and
wherein the monitoring unit comprises at least one of:
a sensor;
a wireless device which communicates with the sensor and is controlled by the network monitoring system; and
software installed and running on the wireless device.

15. The non-transitory computer-readable storage medium of claim 13,
wherein configuring the instructions on the monitoring unit further causes the monitoring unit to send the instructions to the access point be executed by the access point, wherein the instructions comprise a service discovery request and further indicate performing discovery based on at least one of the mDNS protocol and a Discovery and Launch (DIAL) protocol.

16. The non-transitory computer-readable storage medium of claim 13, wherein the method further comprises:
monitoring network attributes associated with the monitoring unit;
responsive to a change in a network attribute associated with the monitoring unit, receiving, by the network monitoring system from the service manager, a first updated list of discoverable servers for the monitoring unit;
responsive to a change in a policy managed by the service manager, receiving, by the network monitoring system from the service manager, a second updated list for the monitoring unit and all monitoring units affected by the change in the policy; and
responsive to a change in a global cache associated with all servers of the WLAN, receiving, by the network monitoring system from the service manager, a third updated list for all monitoring units affected by the change in the global cache.

17. The non-transitory computer-readable storage medium of claim 13, wherein the generated instructions further indicate at least one of:
a frequency or interval at which to execute the instructions; and
one or more servers or services on which to perform the mDNS discovery.

18. The non-transitory computer-readable storage medium of claim 13, wherein the method further comprises at least one of:
subsequent to obtaining the metrics and information, displaying, on a display associated with the network monitoring system, the obtained metrics and information, which allows a user associated with the display to modify the generated instructions to be configured on the monitoring unit and executed by the access point;
subsequent to synchronizing the obtained metrics and information with the service manager of the WLAN, displaying, on a display associated with the WLAN via the service manager, the obtained metrics and information; and
displaying the obtained metrics and information on a display of an integrated system which comprises the WLAN and the network monitoring system.

19. The non-transitory computer-readable storage medium of claim 13, wherein the policies comprise at least one of:
dynamic policies based on changes to a role or location of a user of a device searching for discoverable servers via the access point; and
temporary policies based on changes to a location of an access point or an end device associated with the access point.

20. A computer system, comprising:
a processor; and
a storage device storing instructions that when executed by the processor cause the processor to perform a method, the method comprising:
sending, by a network monitoring system to a service manager of a wireless local area network (WLAN), a message indicating registration information associated with a monitoring unit of the monitoring system, wherein the monitoring unit communicates with and is located within a predetermined distance of an access point of the WLAN;
receiving, by the network monitoring system, a list of discoverable servers in the WLAN associated with the monitoring unit;
generating, based on the list of discoverable servers, instructions to be configured on the monitoring unit and executed by the access point of the WLAN, wherein the instructions indicate performing discovery based on a multicast Domain Name Service (mDNS) protocol and determining reachability of the discoverable servers,
wherein configuring the instructions on the monitoring unit causes the monitoring unit to monitor one or more services indicated in the registration information;
obtaining, in response to the executed instructions, metrics associated with the mDNS discovery and information indicating the determined server reachability;
integrating the network monitoring system and the WLAN by synchronizing the obtained metrics and information with the service manager of the WLAN; and
orchestrating, by the service manager of the WLAN, policies for the network monitoring system based on the integration of the network monitoring system and the WLAN.
